(19) United States
(12) Patent Application Publication
(10) Pub. No.: US 2019/0006060 A1
(43) Pub. Date: Jan. 3, 2019

(54) CONTINUOUSLY BONDED SMALL-DIAMETER CABLE WITH ELECTRICAL RETURN ON OUTER WIRES

(71) Applicant: Schlumberger Technology Corporation, Sugar Land, TX (US)

(72) Inventors: Joseph Varkey, Sugar Land, TX (US); Jushik Yun, Sugar Land, TX (US); Sheng Chang, Sugar Land, TX (US); Burcu Unal Altintas, Richmond, TX (US); Ricardo Vanegas, Houston, TX (US)

(21) Appl. No.: 16/104,596

(22) Filed: Aug. 17, 2018

Related U.S. Application Data
(62) Division of application No. 14/359,002, filed on May 16, 2014.
(60) Provisional application No. 61/564,506, filed on Nov. 29, 2011.

(51) Int. Cl. H01B 3/00; H01B 11/18; H01B 7/18

(52) U.S. Cl. CPC H01B 3/002; H01B 11/1834; H01B 13/22; H01B 7/18

(57) ABSTRACT

A small-diameter, continuously bonded cable and a method for manufacturing the same includes at least one longitudinally extending inner metallic component with a tie layer of an amended polymer material surrounding and bonded thereto in steps of heating and extruding. A longitudinally extending outer metallic component is radially spaced from the at least one inner metallic component and incased in a polymer material jacket layer in heating and extruding steps. The polymer materials insulate the metallic component for conducting electrical power and/or data signals.

### CROSS-REFERENCE TO RELATED APPLICATIONS

This application is a divisional of and claims priority to U.S. patent application Ser. No. 14/359,002, filed May 16, 2014, which is a 371 of International Application No. PCT/US2012/066990, filed Nov. 29, 2012, which claims benefit of U.S. Provisional Patent Application Ser. No. 61/564,506, filed Nov. 29, 2011. Each of the aforementioned related patent applications is herein incorporated by reference.

### BACKGROUND

The statements in this section merely provide background information related to the present disclosure and may not constitute prior art.

The present disclosure is related in general to wellsite equipment such as oilfield surface equipment, oilfield cables and the like.

Oil and gas exploration continues to expand into increasingly difficult environments. Cables used in oilfield operations must be able to withstand increasingly high temperatures and high pressures and must resist corrosive materials found in the depths of the well. Innovations in downhole tools have increased the need for electrical power transmission downhole. This is also true of small-diameter oilfield cables such as slicklines.

Conventional slicklines consist of solid circular wireline cables used only for mechanical operations. Depending on well conditions, slicklines are made of different metals including improved plough steel, stainless steel, or a steel alloy. While conventional slickline cables are incased in polymeric jackets, damage to the jacketing can allow corrosive materials to damage the metallic components inside. Additionally, gaps between the metallic components and the jacketing can create a pathway for high-pressure gases to travel along the cable, allowing more extensive damage to the cable and the possibility for high-pressure gases to escape at the well surface.

When polymer insulated or jacketed metallic members are run into and out of an oil well, there are mechanical forces acting at the interfaces between metals and polymers. There may be separation of polymer from the metallic interfaces due to the deformation of polymer when such components are bent, when the cable passes over sheaves or rollers, when the cable passes through a stuffing box or packers that are used for pressure control, when there is a coefficient of thermal expansion difference between polymer and metal, when there is gas migration between polymer and metal interface, and when any similar operations are performed. These physical stresses may cause the polymeric covering to pull away from the metal and leave air gaps. In the case of electrical conductors, these air gaps may lead to the development of coronas.

It remains desirable to provide improvements in small diameter wireline cables.

### SUMMARY

In the embodiments described below, a small-diameter cable has all materials bonded to one another and all metallic materials separated by polymeric insulation. This insulation protects the metallic components against infiltration of and damage by downhole materials. It also allows all metallic components to be used for electrical transmission.

In this small-diameter, continuously bonded, polymer-jacketed cable, the metallic elements may be used for electrical power and telemetry signal transmission. The bonding is accomplished by passing the metal through a heat source, such as an infrared heat source to alter its surface immediately prior to extruding a polymer amended to bond to metal. As these jacketed elements are brought together in a subsequent manufacturing run, they are passed through another heat source to soften the polymer and allow them to bond to each other and be shaped into a circular profile. Once a cable core of these elements has been created, the same process is used to apply outer, polymer-jacketed metallic strength members.

The embodiments discussed in this disclosure use a variety of metals, alloys and platings as well as polymer jacketing materials chosen for their insulating and chemical protective properties and their abilities to bond to metal.

The embodiments of the present disclosure particularly relate to an electrically conductive longitudinally extending cable. The cable comprises at least one longitudinally extending inner metallic component; an amended polymer material tie layer surrounding and bonded to the at least one inner metallic component to form a coated component being at least a portion of a cable core, the amended polymer material being amended to facilitate bonding to the at least one inner metallic component; a longitudinally extending outer metallic component radially spaced from the at least one inner metallic component; and a polymer material outer jacket layer surrounding, incasing and bonded to the outer metallic component, wherein the tie layer is directly or indirectly bonded to the outer jacket layer to form the cable as a continuously bonded electrically conductive cable with the metallic components individually electrically insulated from one another.

A method for manufacturing an electrically conductive longitudinally extending cable comprises providing at least one longitudinally extending inner metallic component; heating a surface of the at least one inner metallic component to modify the surface and facilitate a bonding of the at least one inner metallic component to a polymer material layer; extruding an amended polymer material over the at least one inner metallic component while heated to bond the amended polymer material to the at least one inner metallic component as the polymer material layer and form an inner coated component as at least a portion of a cable core, the amended polymer material being amended to facilitate bonding to the at least one inner metallic component; providing at least one longitudinally extending outer metallic component radially spaced from the at least one inner metallic component; heating a surface of the at least one outer metallic component to modify the surface and facilitate a bonding of the at least one outer metallic component to a polymer material outer jacket layer; and extruding a polymer material over the at least one outer metallic component while heated to bond the polymer material to the at least one outer metallic component and to the polymer material layer of the inner coated component as the polymer material outer jacket layer and form the cable as a continuously bonded electrically conductive cable with the metallic components individually electrically insulated from one another interface.

### BRIEF DESCRIPTION OF THE DRAWINGS

These and other features and advantages of the present disclosure will be better understood by reference to the following detailed description when considered in conjunction with the accompanying drawings wherein:

FIGS. 1A and 1B are radial cross-sectional views of cable components and a completed cable adjacent a schematic block diagram of the cable manufacturing equipment according to a first embodiment of the present disclosure;

FIG. 2 is a radial cross-sectional view of the completed cable shown in FIG. 1B as used to transmit electrical power;

FIG. 3 is radial cross-sectional view of cable components and a completed cable adjacent a schematic block diagram of the cable manufacturing equipment according to a second embodiment of the present disclosure;

FIG. 4 is radial cross-sectional view of cable components and a completed cable adjacent a schematic block diagram of the cable manufacturing equipment according to a third embodiment of the present disclosure; and

FIG. 5 is partial cut-away perspective view of a portion of the completed cable shown in FIG. 4.

### DETAILED DESCRIPTION

The methods described herein are for making and using metallic wire oilfield cable components with continuously bonded polymeric jackets. However, it should be understood that the methods may equally be applied to other metallic components having bonded polymeric jackets, and that methods for making and using such metallic components having bonded polymeric jackets are also within the scope of the present disclosure.

Bonding to the metal surface is used to prevent separation of polymer from metal at the polymer and metal interface due to the dynamics of going over a sheave, passing through a stuffing box or packers that are used for pressure control, and coefficient of thermal expansion differences between polymer and metal. Bonding to the metal surface is also used to prevent gas migration between polymer and metal interface. Bonding techniques include modifying metal surfaces through exposure to heat sources to facilitate bonding with polymers, and using polymers amended to facilitate bonding with those metals. By eliminating the presence of gaps between the metallic components and the polymers extruded over those components, these embodiments may greatly minimize the occurrence of coronas and eliminate potential pathways for downhole gases inside the insulation. These embodiments may be advantageously used individually as slickline cables capable of telemetry transmission for battery-operated downhole tools, for example, as part of monocable or coaxial cable embodiments, as conductor or conductor/strength member components in hepta-configuration cables, and as components in other multi-conductor wireline cable configurations, as will be appreciated by those skilled in the art.

The metallic wires used at the cores of the components described herein may comprise: copper-clad steel; aluminum-clad steel; anodized aluminum-clad steel; titanium-clad steel; alloy 20Mo6HS; alloy GD31Mo; austenitic stainless steel; high strength galvanized carbon steel; titanium clad copper; and other metals, as will be appreciated by those skilled in the art.

A tie layer polymer may comprise a modified polyolefin. Where needed to facilitate bonding between materials that would not otherwise bond, the polymer may be amended with one of several adhesion promoters such as, but not limited to: unsaturated anhydrides, (mainly maleic-anhydride, or 5-norbornene-2,3-dicarboxylic anhydride); carboxylic acid; acrylic acid; and silanes. Trade names of commercially available, amended polyolefins with these adhesion promoters include: ADMER® from Mitsui Chemical; Fusabond® and Bynel® from DuPont; and Polybond® from Chemtura. Other suitable adhesion promoters may also be employed, as desired.

The tie layer polymer may comprise a modified TPX (4-methylpentene-1 based, crystalline polyolefin) polyolefin. Where needed to facilitate bonding between materials that would not otherwise bond, this polymer may be amended with one of the adhesion promoters described above. TPX™ material is available from Mitsui Chemical.

The modified polymer may comprise modified fluoropolymers. Modified fluoropolymers containing adhesion promoters may be used where needed to facilitate bonding between materials that would not otherwise bond. As listed above these adhesion promoters include unsaturated anhydrides (mainly maleic-anhydride or 5-norbornene-2,3-dicarboxylic anhydride), carboxylic acid, acrylic acid, and silanes. Examples of commercially available fluoropolymers modified with adhesion promoters include: PFA (perfluoroalkoxy polymer) from DuPont Fluoropolymers; modified PFA resin; Tefzel® from DuPont Fluoropolymers; modified ETFE resin, which is designed to promote adhesion between polyamide and fluoropolymer; Neoflon™-modified fluoropolymer from Daikin Industries, Ltd., which is configured to promote adhesion between polyamide and fluoropolymer; FEP (Fluorinated ethylene propylene) from, for example, Daikin Industries, Ltd.; ETFE (Ethylene tetrafluoroethylene) from Daikin Industries, Ltd.; and EFEP (ethylene-fluorinated ethylene propylene) from Daikin Industries Ltd, Inc.

A jacket layer polymer may comprise an unmodified and reinforced material which has a low dielectrical coefficient. A suitable material is a commercially available polyolefin that can be used as is or reinforced with carbon, glass, aramid or any other suitable natural or synthetic fiber. Along with fibers in the polymer matrix, any other reinforcing additives can be used such as, but not limited to: micron sized PTFE; graphite; Ceramer™ from, for example, Ceramer GmbH; HDPE (High Density Polyethylene); LDPE (Low Density Polyethylene); PP (Ethylene tetrafluoroethylene); PP copolymer; and similar materials.

The jacket layer polymer may comprise, for example, a commercially available fluoropolymer. The fluoropolymer material can be used as is or reinforced with carbon, glass, aramid or any other suitable natural or synthetic fiber. Along with fibers in the polymer matrix, any other reinforcing additives can be used such as, but not limited to: micron sized PTFE; graphite; Ceramer™; ETFE (Ethylene tetrafluoroethylene) from Du Pont; ETFE (Ethylene tetrafluoroethylene) from Daikin Industries Ltd, Inc.; EFEP (ethylene-fluorinated ethylene propylene) from Daikin Industries Ltd, Inc.; PFA (perfluoroalkoxy polymer) from Dyneon™ Fluoropolymer; PFA (perfluoroalkoxy polymer) from, for example, Solvay Slexis, Inc.; PFA (perfluoroalkoxy polymer) from Daikin Industries Ltd, Inc.; and PFA (perfluoroalkoxy polymer) from DuPont Fluoropolymer, Inc.

The jacket layer material may comprise a polyamide such as: Nylon 6; Nylon 66; Nylon 6/66; Nylon 6/12; Nylon 6/10; Nylon 11; and Nylon 12. Trade names of commercially available versions of these polyamide materials are: Orgalloy®, RILSAN® and RILSAN® from Arkema; BASF Ultramid® and Miramid® from BASF; Zytel® from DuPont Engineering Polymers; Pipelon® from DuPont

The materials and processes described hereinabove can be used to form a number of different types of metallic wire cable components, such as wireline cable components or the like, with continuously bonded polymeric jackets. The embodiments discussed in more detail below disclose different combinations of materials which may be used. In each embodiment, the metallic wire used may be any of those discussed above. The specific materials for polymeric layers are also discussed above. The heating and extrusion processes used may be any of those discussed hereinbelow.

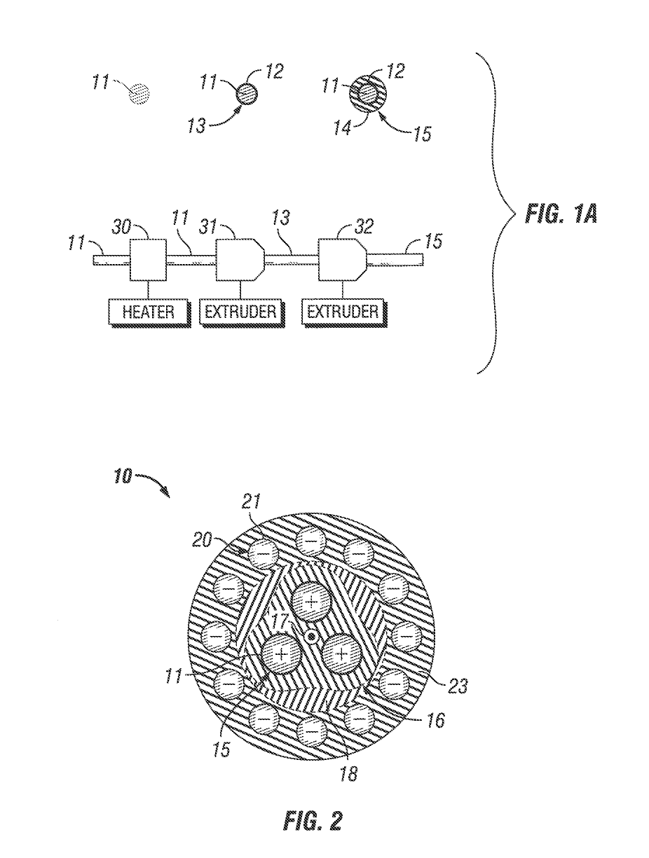

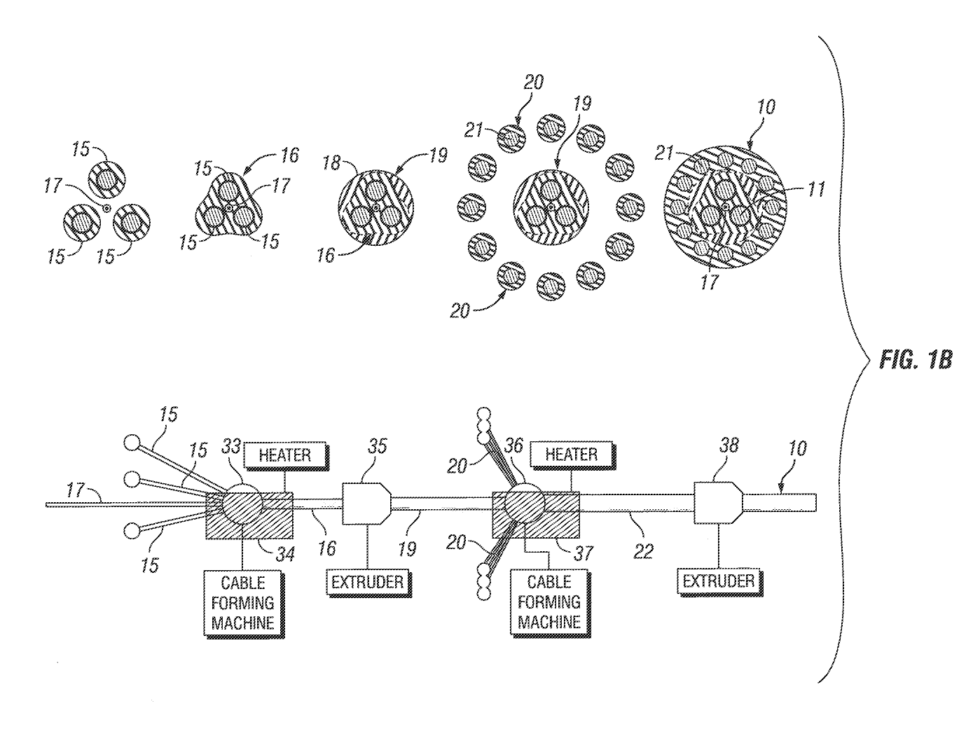

A first embodiment is a small-diameter, continuously bonded cable 10 with electrical return on the outer wires. In a non-limiting example, the diameter of the cable 10 may be about less than 0.300 inches. This embodiment begins with a bonded, polymer coated metallic component 15 as shown in FIG. 1A. An individual inner metallic component such as a wire 11 is treated by heat in a first heater 30, such as an infrared heater, to modify the wire surface prior to extrusion of a polymeric material (amended to bond to the metal). The amended polymer may be in the form of a thin tie or first layer 12 that is extruded onto the inner wire 11 in a first extruder 31 to bond to the wire component and form a coated component 13. The tie layer 12 bonds to a second layer 14 of polymer insulation. The second layer 14 is extruded onto the coated component 13 over the tie layer 12 in a second extruder 32 to form the polymer coated component 15. In the alternative, the tie layer 12 can form the entire polymeric coating of the coated component 15.

As shown in FIG. 1B, a number of these bonded polymer coated wire components 15 are cabled together (and bond to each other) to create a cable core 16. As an option, a fiber-optic component 17 may be placed at the center of the core 16 to provide telemetry capability. For example, three of the coated wires 15 are combined with the fiber-optic component 17 in a first cable forming machine 33 and passed through a second heater 34, such as an infrared heater, to form the cable core 16. An inner jacket layer 18 of polymer material is extruded onto the heated core 16 in a third extruder 35 to form a jacketed cable core 19. Additional, possibly smaller-diameter bonded, polymer coated outer metallic component wires 20 are cabled around the jacketed cable core 20 in a second cable forming machine 36. As with the larger-diameter wires 11, the smaller-diameter metallic wire components 21 may be coated with the tie layer 12, with or without the second layer 14. The jacketed cable core 19 and the coated wires 20 are heated by a third heater 37, such as an infrared heater, to bond together and form a cable sub-assembly 22. An outer jacket 23 of a polymer material is extruded in a fourth extruder 38 over the sub-assembly 22 to form the completed cable 10. The polymer jacket 23 bonds to an exposed portion of the outer surface of the jacketed cable core 19 and to the exposed portions of the outer surfaces of the coated wires 20 to create the continuously bonded cable 10 with individually insulated conductors.

The equipment shown in FIGS. 1A and 1B is operated as follows:
1. The components 15 used in creating this design begin with a solid or stranded metal conductor/strength wire 11 that is treated by an heat source 30, such as an infrared heat source, to modify its surface to facilitate bonding.
2. A first “tie layer” of amended polymer material 12 (designed to bond to metal and an ensuing polymer layer) is extruded (first extruder 31) over and bonded to the heat-treated metal wire 11.
3. A second layer of polymer material 14 is extruded (second extruder 32) over and bonded to the tie layer 12. (In an embodiment, the tie layer may be omitted and this polymer layer may be amended to bond to the infrared-heat-treated metal.)
4. A number of the components 15, polymer coated wires, created in Steps 1 through 3 are brought together, such as in a separate manufacturing line. A central component, such as a fiber optic component 17, may be placed at the center of the cable core 16.
5. Immediately after being slightly softened or surface melted by exposure to an heat source 34, such as an infrared heat source, the polymer-insulated components 15 are cabled together. The outer polymer layers 14 (or 12) deform against and bond to one another to form the cable core 16.
6. The cable core 16 may be either drawn through a shaping die (not shown) and/or additional polymer material 18 may be extruded (third extruder 35) over the cable core to create a substantially circular profile jacketed cable core 19.
7. A number of the same type of polymer coated outer wire components 20 created in Steps 1 through 3 (which may be smaller in diameter than those used in the cable core), are treated by the infrared heat source 37 immediately before being brought together over the cable core 19.
8. The completed cable sub-assembly passes through a shaping die and/or additional polymer material 23 is extruded (fourth extruder 38) over the cable sub-assembly 22 to create the substantially circular profile continuously bonded cable 10.

As shown in FIG. 2, the first embodiment completed continuously bonded cable 10 includes, starting from the center, the fiber-optic component 17 surrounded by the coated wires 15. The coated wires 15 are incased in the inner jacket layer 18 to form the cable core 16. The smaller-diameter coated outer wires 20 surround the cable core 16 and all of these components incased in the outer jacket layer 23. The central metallic components, the wires 11, can be used to transmit electrical power, signals and/or data downhole as signified by a “+” symbol. The outer metallic components, the wires 21, are used as a return path as signified by a “−” symbol. Because each metallic component is individually insulated, any of the outer wires 21 could conceivably be used with any of the inner wires 11 to provide multiple electrical paths. The cable 10 is bonded from the center to the outer surface of the outer jacket layer 23 and the whole cable 10 is a composite structure.

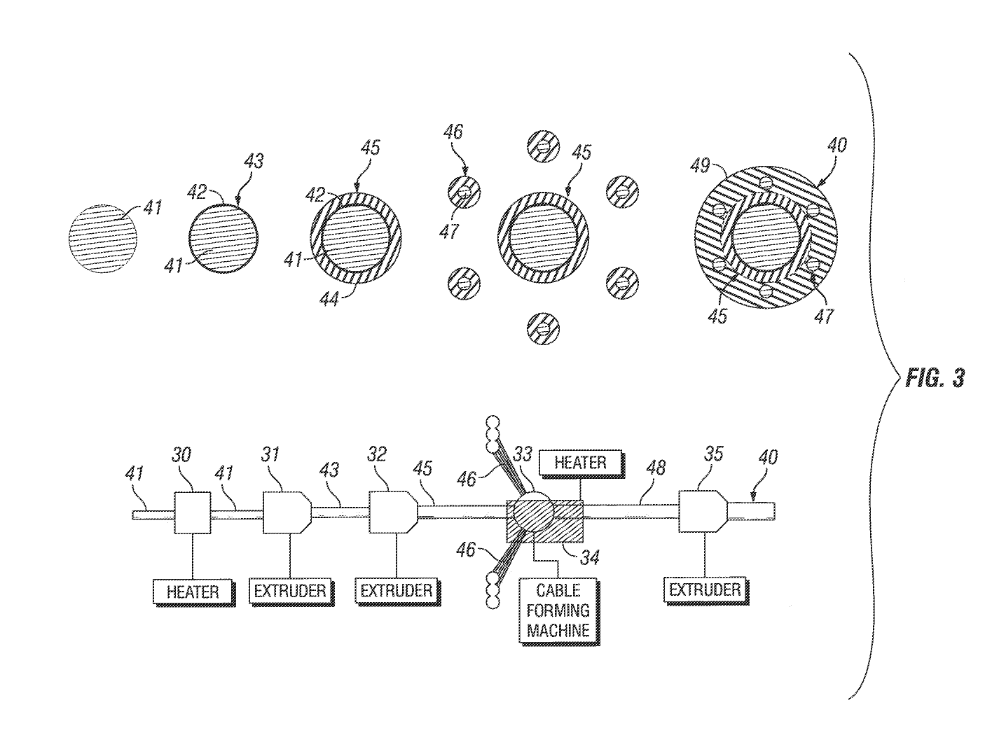

A second embodiment small-diameter, continuously bonded cable 40 with electrical return on outer cut-through protection wires is shown in FIG. 3. In a non-limiting example, the diameter of the cable 40 may be less than about 0.300 inches. The cable 40 is assembled from a number of continuously bonded metallic wires used as strength members, and/or power or data carriers. One of these metallic wires 41 serves as the strength member and as the positive path for an electrical signal at the center of the cable 40. A number of smaller bonded metallic wires 47 (which serve as cut-through protection and as a return path for the electrical current) are cabled over the central wire 41. The jackets on the outer metallic wires 47 are melted slightly during cabling to allow them to bond to the inner polymeric jacket and to fill interstitial voids. The manufacturing process is as follows:
1. The cable 40 begins with the inner metallic wire core component 41 that is treated by the first heat source 30, such as an infrared heat source, to alter the metal's surface and facilitate bonding.
2. A “tie layer” of polymer material 42 amended to bond to metal is extruded over and bonds to the core wire 41 in the first extruder 31 to form a coated component 43.
3. A layer of un-amended polymer material 44 is extruded over and bonds to the tie layer 42 in the second extruder 32 to form a polymer coated wire component or cable core 45.
4. A number of outer component smaller-diameter polymer coated wires 46 (which serve as cut-through protection), constructed in the same manner described in Steps 1 through 3 with the metallic component wires 47, are treated by the second heat source 34 as they are cabled over the polymer jacketed cable core 45 in the cable forming machine 33.
5. The polymer material jackets over the smaller wires 47 deform to fill all interstitial voids between themselves and the core 45 and bond to the inner polymer jacket 44 to form a cable sub-assembly 48. The cable sub-assembly 48 either passes through a die (not shown) to create a substantially circular outer profile or, if needed, additional polymer material is extruded over the cut-through wire components 46 as an outer jacket layer 49 by the third extruder 35 to achieve a substantially circular profile of the desired thickness.

The smaller-diameter wires 47 on the outside of the cable 40 do not share load with the inner core wire 41. The axial strength of the cable 40 is derived mainly from the core single wire 41. The cable 40 is bonded all the way from the core wire 41 to an outer surface of the outer jacket layer 49.

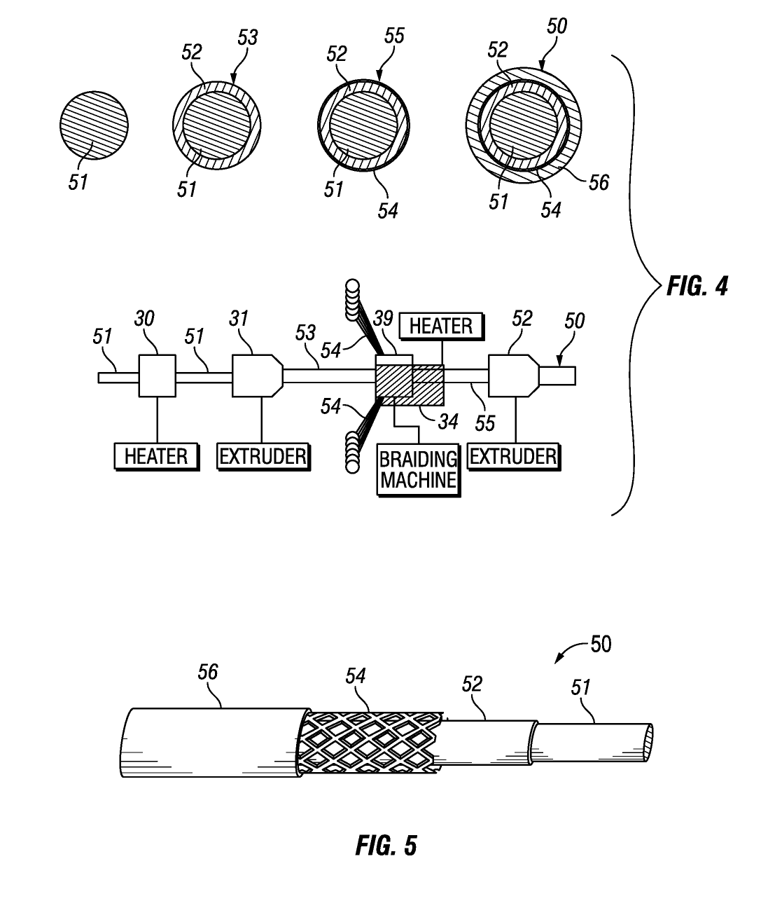

There is shown in FIGS. 4 and 5 a third embodiment small-diameter, continuously bonded cable 50 with electrical return on braided wire strands. In a non-limiting example, the diameter of the cable 50 may be less than about 0.300 inches. The cable 50 is similar to the cable 40, but uses only amended polymer material and replaces the insulated cut-through wires with a layer of thin, braided wire strands to form a shield layer such as that found in a coaxial cable. A larger-diameter inner metallic wire component 51 serves as the strength member and as the positive path for an electrical signal at the center of the cable 50. Smaller-diameter braided wire strands 54 (which serve as a return path for the electrical current) are cabled over the central wire 51.

The braided wire strands 54 are treated by an heat source, such as an infrared heat source, as they are cabled onto the inner jacket to modify their surface properties and facilitate bonding with the amended polymer material. An outer amended polymer jacket completes the cable 50. The manufacturing process is as follows:
1. The cable 50 begins with the metallic wire component 51 that is treated by the first heat source 30 to alter the metal's surface and facilitate bonding.
2. A layer of amended polymer material 52 is extruded over and bonds to the heated wire component 51 in the first extruder 31 to form a coated wire 53 cable core.
3. A number of thin metallic strands 54 are treated by the second heat source 34 to modify their surface properties immediately prior to being braided over and bonded to the inner amended polymer material jacket or tie layer 52 in a cable braiding machine 39 to form a cable sub-assembly 55.
4. A final outer jacket layer 56 of amended polymer material is extruded over and bonded to the braided, heat-treated wires 54 in the second extruder 32 to complete the cable 50.

Suitable applications for the cables 10, 40 and 50 described hereinabove include slickline cables or multiline cables, wherein the metallic components may be used as single or multiple strength members and power/data carriers. The cables 10, 40 and 50 each include a longitudinally extending core having at least one metallic wire component incased in at least one layer of polymer material bonded to the wire component. The wire component provides an electrical path for power and/or data signals. The core is surrounded by at least one outer metallic component that provides a return path for the power and/or data signals. The outer metallic component can be a plurality of wires of smaller diameter than the core wire or wires, or a metallic braiding. The outer metallic component is incased in a polymer material such that all of the metallic components are insulated from one another and continuously bonded together to prevent separation of the polymer from the metal interface to further prevent gas migration between the polymer layers and the metallic component interfaces.

The cables 10, 40 and 50 described hereinabove may be utilized within a wellbore penetrating a subterranean formation in a variety of wellbore operations including, but not limited to, with wellbore devices attached at an end thereof to perform operations in the wellbores that may contain gas and oil reservoirs. The cables 10, 40 and 50 may be used to interconnect well intervention tools such as mechanical service tools, perforating tools, well logging tools, such as gamma-ray emitters/receivers, caliper devices, resistivity-measuring devices, seismic devices, neutron emitters/receivers, and the like, to one or more power supplies and data logging equipment outside the well. The cables 10, 40 and 50 may also be used in seismic operations, including subsea and subterranean seismic operations. The cables may also be useful as permanent monitoring cables for wellbores.

The cables 10, 40 and 50 may be utilized in a wellbore to convey via gravity, via injection of fluids, or via utilization of a tractor, explosive devices or equipment for performing wellbore operations for the purpose of creating or enhancing communication with the wellbore to facilitate well production or the enhancement of well production, including but not limited to, fracturing, stimulation, and the like. The wells or wellbores may be vertical, deviated or horizontal. The cables 10, 40 and 50 may be utilized with mechanisms or tools for wellbore operations for creating communication with the wellbore such as shifting sleeves, timed explosive devices, or other mechanisms designed to create communication with the wellbore. The cables 10, 40 and 50 may be utilized to convey mechanical devices, logging tools or equipment for the purpose of wellbore operations comprising intervening with, monitoring of, or abandoning of a well.

The preceding description has been presented with reference to present embodiments. Persons skilled in the art and technology to which this disclosure pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

We claim:

1. An electrically conductive longitudinally extending cable, comprising:
at least one longitudinally extending inner metallic component;
an amended polymer material tie layer surrounding and bonded to the at least one inner metallic component to form a coated component being at least a portion of a cable core, the amended polymer material being amended to facilitate bonding to the at least one inner metallic component;
a longitudinally extending outer metallic component radially spaced from the at least one inner metallic component; and
a polymer material outer jacket layer surrounding, incasing and bonded to the outer metallic component, wherein the tie layer is directly or indirectly bonded to the outer jacket layer to form the cable as a continuously bonded electrically conductive cable with the metallic components individually electrically insulated from one another.

2. The cable of claim 1 further comprising another layer of a polymer material surrounding and bonded to the tie layer.

3. The cable of claim 1 wherein the cable core comprises at least two of the coated components bonded together by heating.

4. The cable of claim 3 wherein the coated components are surrounded by and bonded to an inner jacket layer of polymer material to form the cable core.

5. The cable of claim 1 wherein the outer metallic component comprises a plurality of metallic wires each surrounded by and bonded to a separate tie layer of the amended polymer material and being incased in the outer jacket layer.

6. The cable of claim 1 wherein the outer metallic component comprises a plurality of metallic strands braided about the cable core and surrounded by the outer jacket layer.

7. The cable of claim 1 wherein the cable core further comprises a longitudinally extending fiber-optic component.

8. A method of utilizing the cable of claim 1 in a wellbore comprising introducing the cable into the wellbore and performing at least one wellbore operation in the wellbore.

9. A method for manufacturing an electrically conductive longitudinally extending cable, comprising:
providing at least one longitudinally extending inner metallic component;
heating a surface of the at least one inner metallic component to modify the surface and facilitate a bonding of the at least one inner metallic component to a polymer material layer;
extruding an amended polymer material over the at least one inner metallic component while heated to bond the amended polymer material to the at least one inner metallic component as the polymer material layer and form an inner coated component as at least a portion of a cable core, the amended polymer material being amended to facilitate bonding to the at least one inner metallic component;
providing at least one longitudinally extending outer metallic component radially spaced from the at least one inner metallic component;
heating a surface of the at least one outer metallic component to modify the surface and facilitate a bonding of the at least one outer metallic component to a polymer material outer jacket layer; and
extruding a polymer material over the at least one outer metallic component while heated to bond the polymer material to the at least one outer metallic component and to the polymer material layer of the inner coated component as the polymer material outer jacket layer and form the cable as a continuously bonded electrically conductive cable with the metallic components individually electrically insulated from one another.

10. The method of claim 8 wherein the extruded amended polymer material forms a tie layer and further comprising extruding a layer of polymer material over the tie layer to form the inner coated component

11. The method of claim 8 further comprising providing another inner coated component and heating the inner coated components to bond the polymer material layers together.

12. The method of claim 11 further comprising extruding an inner jacket layer of polymer material over the inner coated components to form the cable core.

13. The method of claim 12 further comprising providing a longitudinally extending fiber-optic component and extruding the inner jacket layer over the fiber-optic component and the coated components to form the cable core.

14. The method of claim 8 including forming the at least one outer metallic component by braiding together a plurality of metallic wire strands.

15. A method for manufacturing an electrically conductive longitudinally extending cable, comprising:
providing at least one longitudinally extending inner metallic component;
heating a surface of the at least one inner metallic component to modify the surface and facilitate a bonding of the at least one inner metallic component to a polymer material layer;
extruding a first polymer material over the at least one inner metallic component while heated to bond the first polymer material to the at least one inner metallic component as the polymer material layer and form an inner coated component as at least a portion of a cable core;
providing a plurality of longitudinally extending outer metallic components radially spaced from the at least one inner metallic component;
heating a surface of each of the outer metallic components to modify the surfaces and facilitate a bonding of the outer metallic components to a polymer material outer jacket layer; and
extruding a second polymer material over the outer metallic components while heated to bond the second polymer material to the outer metallic components and to the polymer material layer of the inner coated component as the polymer material outer jacket layer and form the cable as a continuously bonded electrically conductive cable with the metallic components individually electrically insulated from one another.

16. The method of claim 15 wherein the outer metallic components have a smaller diameter than the at least one inner metallic component.

17. The method of claim 15 wherein the first polymer material is amended to facilitate bonding to the at least one inner metallic component.

18. The method of claim 17 including extruding a third polymer material over the first polymer material to form the polymer material layer of the inner coated component.

19. The method of claim 15 including heating a plurality of the inner coated components and bonding the polymer material layers together to form the cable core.

20. The method of claim 19 including extruding an outer jacket of polymer material over cable core while heated to form a jacketed cable core.
